(19) United States
(12) Patent Application Publication
(10) Pub. No.: US 2015/0314997 A1
(43) Pub. Date: Nov. 5, 2015

(54) CABLE BREAKAGE DIAGNOSIS IN A CRANE

(71) Applicant: HIRSCHMANN AUTOMATION AND CONTROL GMBH, Neckartenzlingen (DE)

(72) Inventor: Leo PETRAK, Marxzell (DE)

(21) Appl. No.: 14/443,550

(22) PCT Filed: Oct. 21, 2013
(86) PCT No.: PCT/EP2013/071972

§ 371 Date: May 18, 2015

(30) Foreign Application Priority Data
Nov. 29, 2012 (DE) 10 2012 221 909.9

(51) Int. Cl. B66C 23/90; B66C 13/16; G01L 5/04; B66C 13/18

(52) U.S. Cl. CPC B66C 23/905; B66C 13/18; B66C 13/16; G01L 5/04

(57) ABSTRACT

A crane has a base, an adjustable-length boom pivotal on the base and formed by at least one outer boom element and at least one inner base-mounted boom element telescoping with the outer element, and a cable extending between an outer end of the outer boom element and the inner boom element so as to be pulled out on extension of the outer boom element from the inner boom element. Such a crane is operated by detecting tension in the cable and generating an output corresponding thereto, determining when the tension in the cable is outside a predetermined noncritical range, and taking action to suspend operation of the crane on determination that the tension is outside the noncritical range.

### CROSS REFERENCE TO RELATED APPLICATIONS

This application is the US-national stage of PCT application PCT/EP2013/071972 filed 21 Oct. 2013 and claiming the priority of German patent application 102012221909.9 itself filed 29 Nov. 2012.

### FIELD OF THE INVENTION

The present invention relates to a crane and a method of operating a crane, having a base having a pivotable and boom formed by at least two telescoping boom elements, and a longitudinal angle transmitter having at least one cable by which the length of the telescopic boom is detected, and a method of operating such a crane, according to the respective features of the preambles of the independent claims.

### BACKGROUND OF THE INVENTION

Cranes having pivotable, rotatable, and telescopic booms that have a plurality of boom elements and comparable work vehicles having work elements that may be changed in length (so that the present invention not only relates to cranes having telescopic booms but more generally to such work vehicles) are known. A mobile crane, for example, has a base that can transport the crane over streets and the like to its operation site. A pivotal structure is often provided on the base, and a boom is either mounted on the base or on the pivotal structure. In order for the crane to work in a flexible manner, the boom is made up of a boom element that is pivotally mounted directly on the base or on the pivotal structure and that has an boom element. These boom elements may be axially changed in their position to one another, so that the length of the boom may be changed (telescoped). For the operation, but also in particular for the safety of operating the crane, it is indispensable to know the actual adjusted length of the boom because the load that may be safely suspended has to be determined as a function of the boom length. Putting it in simple terms, the load is, this way, significantly lighter for a fully extended boom and at a flat attack angle to the base than when the boom is retracted and, for example, has been pivoted to extend nearly vertically from the base. In order to ensure the operation of such a crane in a manner particularly relevant to safety, so-called longitudinal angle transmitters have become known. These longitudinal angle transmitters detect the actual angle of the boom relative to the base (or the ground) on the one hand and, at the same time, also detect the length of the telescoped boom. For this purpose, by extending the boom and its boom elements, a rope, which conventionally is attached to the outer end of the last boom element, is extended also and the extended length of the rope is detected by the longitudinal angle transmitter in a manner known per se. Owing to the detected length and the attack angle of the boom, these parameters may be supplied to a controller of the crane and be taken into consideration when operating in such a manner that when exceeding unacceptable lengths or angles, the operation of the crane is suspended or at least a warning notice occurs. As the longitudinal angle transmitter including its elements represents a component relevant for safety, it is necessary to take measures to ensure, when detecting and transmitting the output signals of the longitudinal angle transmitter representing the length and the attack angle of the boom, that errors not occur or that the right signals are supplied to the controller situated downstream.

### OBJECTS OF THE INVENTION

Therefore, the object of the present invention is to provide a crane and a method of operating a crane (or generally a work machine having work elements adjustable in length) that prevents the disadvantages described above. In particular, safe operation of the crane is to be ensured at any time or, in the case that this safe operation is no longer sure, a warning is issued in due time.

### SUMMARY OF THE INVENTION

The present invention in regard to the crane is achieved according to the present invention in that a force sensor is provided on the cable to detect the force acting longitudinally on the cable. This ensures that each time that the force sensor detects a specifiable force acting upon the cable, the cable is functioning and, for example, is not broken. In case the cable is damaged, ruptured, or the like, a force deviating from the specified parameter range for an acceptable force is ascertained and is outputted from the force sensor to a controller situated downstream. This controller evaluates the force and may, for example, signal a crane operator that safe operation of the crane is no longer possible. Using the controller, the operator may then react either manually or also automatically. Based on the force measurement (also referred to as cable tension) it is hence possible to react appropriately, in particular, when forces are too high (jamming of the cable, breakage, or the like) or also when forces are too low (in particular, slip), in particular, to suspend the further operation of the crane.

In a further embodiment of the present invention, the cable is a steel rope and/or an electric cable. If the cable is a steel rope, the present invention offers the simple possibility of already at this point retrofitting longitudinal angle transmitters with steel ropes having force sensors. For this purpose, it is merely necessary to mount the force sensor along the steel rope and to ensure that the output signal of the force sensor is transmitted to a controller of the crane. In addition to the steel rope or to replace the steel rope, it is conceivable that the cable is an electric cable. Such a cable makes it advantageously possible, on the one hand to ascertain the boom length and, at the same time, to transfer signals via the electric conductors of the electric cable. In this instance, it is particularly advantageous that, for example, one end of the force sensor is situated at the outer end of the boom and its other end is situated at the end of the electric cable. As the force sensor is thus located at a point furthest from the base or the pivotal structure and the controller is conventionally disposed in the base or the pivotal structure, the signals of the force sensor may be transmitted via the electric cable to the controller.

In a further embodiment of the present invention, means are provided by which the force sensor transmits a signal representing a force acting upon the cable to a controller of the crane. As previously mentioned, these means may be the electric cable that thus fulfills two functions. On the one hand, by unwinding the cable on the longitudinal angle transmitter, the cable detects the length of the telescopic boom and, at the same time, the forces acting upon the cable, more specifically, the signals of the force sensor, are transferred to the controller that is further away. In addition or alternatively, the means may be designed as wireless transmitters for this purpose, so that the output signals of the force sensor may be transferred wirelessly (for example, via radio) to the controller.

With regard to the method of operating a crane, according to the present invention a force sensor on the cable detects the force acting longitudinally on the cable. For this purpose, the detected force may be divided into different ranges. One range includes such forces acting upon the cable that are acceptable and, on the other hand, there are ranges (in particular, ranges below and/or above the acceptable range) that generally represent a problem with the cable, for example, slip, jamming, breakage, or the like. Thus, the detected force acting upon the cable is able, in an advantageous manner, to ensure safe operation of the crane when the detected force is in an acceptable range. If the force deviates from such an acceptable range, appropriate measures, from limiting the operation of the crane to completely suspending its operation, may be taken.

In a further embodiment of the present invention, the force sensor continuously detects (constantly, and conceivably also at intervals) force upon the cable, and transmitting the output signal of the force sensor to the controller continues to be carried out continuously or discontinuously, and then, when a transmitted signal is omitted, the controller recognizes a safety-critical state. For this purpose, it is assumed that the force sensor functions according to specifications and provides a force signal acting upon the cable. It is, however, also important to not only verify that the controller provides the signal, but to also ensure that the transmission occurs according to specifications. In this instance, according to the present invention the transmission is carried out continuously or discontinuously and the controller detects a safety-critical state, for example when the continuously transmitted signal is completely omitted or after exceeding an acceptable time limit. Transmitting and monitoring the signal discontinuously has the advantage of saving energy because the signal does not have to be constantly transmitted and also because the controller does not have to constantly receive the signals transmitted discontinuously. This way, the force sensor may be designed and suited in such a manner to transmit a signal representing the force to the controller within the framework of sequential impulses via the cable and/or in a wireless manner. If this impulse sequence or also parts of the impulse sequence are omitted, it is signaling to the controller that the transmission has not been carried out according to specifications. If an impulse sequence is only omitted for a short period of time, it may be concluded that the transmission was also only disrupted for a short period of time, so that a safety-critical state is not yet reached. If, however, a specified time threshold within which an impulse sequence should have been detected is omitted, it is a sign of a transmission not according to specifications, so that as a result a safety-critical state may be concluded to have occurred. In addition, by detecting on the basis of a limited temporary absence of the impulse sequence, wear conditions may be detected. Breakage of the cable is detected when impulses are completely absent.

In a further embodiment of the present invention, the controller assesses the transmitted signal and, when leaving a non-critical range, the controller detects a safety-critical state. The force acting upon the cable and detected by the force sensor is conventionally in a specific, predetermined range. This range is, however, left when the cable is broken, worn out, is slipping, or the like. Consequently, advantageously the controller assesses the transmitted signal representing the force acting upon the cable. If the signal provided by the force sensor leaves the non-critical range, the controller is able to detect a safety-critical state. In the worst case, this is a cable breakage, resulting in immediate suspension of operation of the crane because safe operation is no longer ensured. On the other hand, this assessment is able to ensure that, for example, wear of the cable is detected and a trend analysis is carried out. As a consequence of the wear, the set point of the force acting upon the cable may be adjusted as a function of the boom length, so that the adjustment is detected as a function of time (in particular, as a function of the operating hours of the crane). Hence, if the magnitude of the force acting upon the cable indicates that the transmitted signal is soon to leave a non-critical range or just has left the range, servicing or, if applicable, replacing the cable may be detected as a safety-critical state.

In a further embodiment of the present invention, transmitting the signal occurs redundantly. In this instance, transmitting the signal redundantly occurs either via the cable designed as a data cable, or only in a wireless manner (via two radio links independent of each other), or via the data cable and in a wireless manner. In this way, a plurality of possibilities for the redundant transmission of the signals representing the force acting upon the cable are provided. For the redundant transmission of the signal via at least one radio channel and respective transmitter/receiver units connected to the controller are provided, so that these transmitter/receiver units wirelessly exchange signals with the controller.

In the following, an embodiment of the present invention is described and shown with reference to FIGS. 1 and 2.

### BRIEF DESCRIPTION OF THE DRAWING

In the drawing:

FIG. 1 is a small-scale and partly schematic side view of the crane according to the invention; and

FIG. 2 is a schematic diagram of the system of this invention.

### SPECIFIC DESCRIPTION OF THE INVENTION

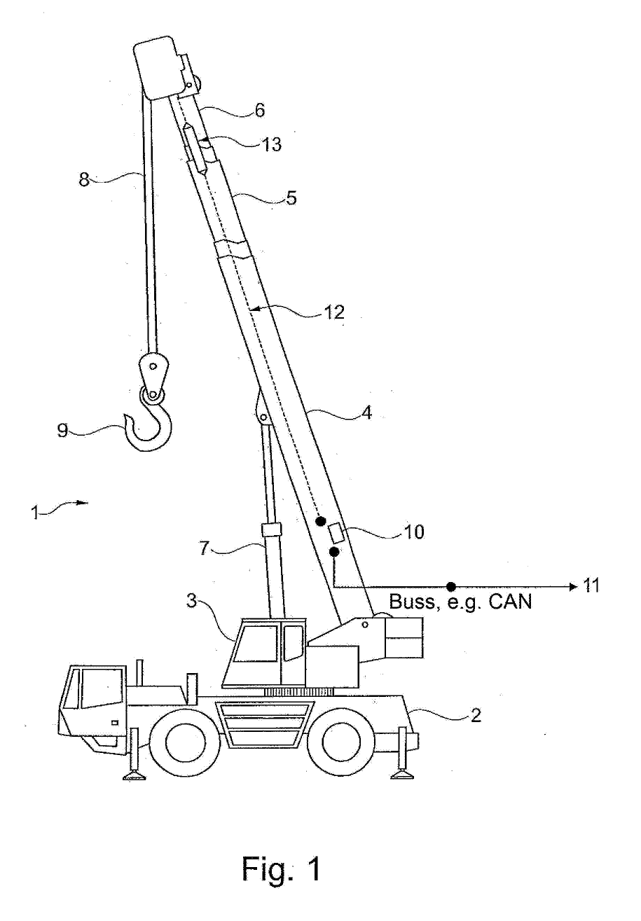

In FIG. 1, insofar as illustrated in detail, a crane 1, for example, has a base 2 (having a drive for a vehicular operation), on which a pivotable structure 3 is carried. A pivotable boom 4 (base boom) on this structure 3 has boom elements 5 and 6 (also only one additional boom element or more than two boom elements) that are telescopic in a manner known per se. This means that the length of the boom 4-6 may be changed, and this changed length has to be detected for the safe operation of the crane 1. In order to be able to angle or pivot the boom 4 relative to the base 2 or the pivotal structure 3, there is, for example, a hydraulic cylinder 7. A rope 8 (crane cable) extends from an unillustrated winch (not shown) on the pivotal structure 3 to its end at a hook 9 on the outer end of the boom element 6. In order to detect the length of boom 4 through 6 and angle relative to pivotal structure 3 or base 2, there is a schematically illustrated longitudinal angle transmitter 10 that is also known per se. This longitudinal angle transmitter 10 is, on the one hand, suited and designed to detect the unillustrated angle of the boom 4 relative to the pivotal structure 3 or base 2. An output signal 11 of the longitudinal angle transmitter 10 is transmitted to an unillustrated controller. In order to detect the actual length of the boom 4-6, a cable 12 is provided between the longitudinal angle transmitter 10 and the outer end of the boom element 6. When the boom elements 5 and 6 are fully retracted, this cable 12 is rolled up on a drum in the longitudinal angle transmitter 10 and when the boom elements 5, 6 extend it is payed out of the longitudinal angle transmitter 10. This process is detected by the longitudinal angle transmitter 10 in a manner known per se so that the output signal 11 not only transmits the actual angle of the boom 4 to the controller, but also the actual or current length of the boom 4 formed by the boom elements 5 and 6.

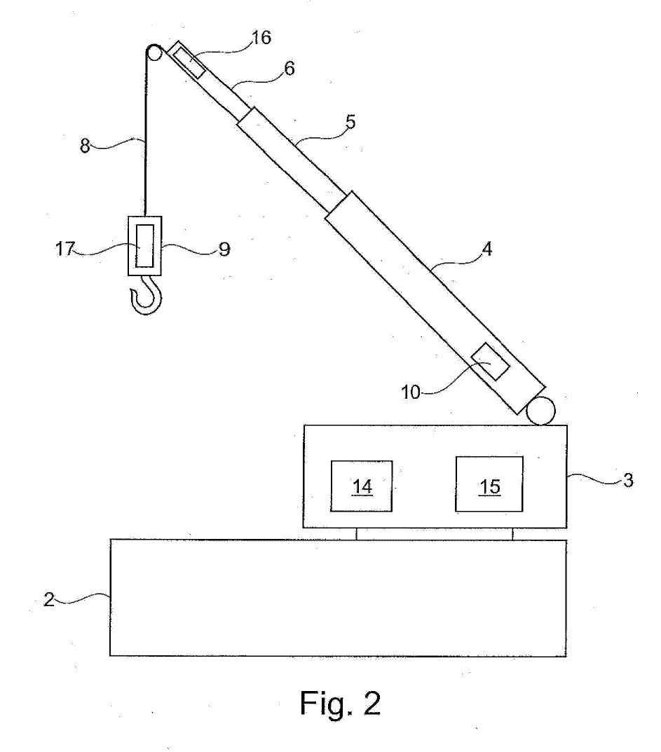

According to the present invention, a force sensor 13 is provided along the cable, and, in the illustrated embodiment according to FIG. 1 is in the outer boom element 6 (that is, toward the outer end of the boom). This, however, is only one illustrated embodiment of a force sensor 13 and its arrangement, and other places along the cable 12 are also conceivable. While the force sensor 13 according to FIG. 1 directly detects the longitudinal tension in the cable 12, such force sensors that indirectly detect (for example, inductively) the force acting upon cable 12 are also usable. Furthermore, under safety-related aspects, two force sensors that are alike or different from each other may also be provided. The cable 12 is either as is known per se a steel rope, so that it is required in this case to transfer the force detected at the boom outer end and acting upon cable 12 via suitable means (see FIG. 2). If the cable 12 is designed as a data cable, the force sensor 13 may be connected to the data cable in a basic manner and its signals may be transmitted to the pivotal structure 3, so that, in this case, the output signal 11 also includes the force acting upon the cable 12.

FIG. 2 illustrates in principal how the individually detected signals of the elements of crane 1 may be transferred to the controller 14. The longitudinal angle transmitter 10 feeds its output signal 11 to the controller 14. Furthermore, a base communicator 15, a boom communicator 16, and a hook communicator 17 are provided. The base communicator 15 is also connected to the controller 14 and suited and designed so as to at least receive signals and, alternatively or additionally to also output radio signals. The same applies to both devices 16 and 17 and the boom communicator 16 is situated in the outer end of the boom element 6 and the hook communicator 17 on the hook 9. The device 16 to which force sensor 13 is then connected wirelessly transmits the forces acting upon cable 12 in a simple or redundant manner to the base communicator 15, so that this device 15 transfers the signals of the force sensor 12 to the controller 14. In addition, it is also conceivable that the parameters of the hook 9, in particular the weight it is carrying, are detected and also transferred wirelessly in a particularly advantageous manner via the hook communicator 17 to the device 16 or directly to the base communicator 15, so that they are also provided to the controller 14. The data transfers previously mentioned occur, as far as possible and reasonable from a technical point of view, wirelessly always in a simple or double (redundant) manner, and the data transfer from the boom communicator 16 to the base communicator 15 may also be occur redundant, both in a wireless and wired manner (via cable 12 designed as a data cable).

It is pointed out once more that the present invention hereinbefore has been described on the basis of a crane but that the present invention is also suitable and applicable to all work vehicles having a length-adjustable element, and the length of the element has in particular to be detected and evaluated under aspects relevant to safety.

1. In a crane having
a base,
a pivotable boom mounted on the base and formed by two telescoping boom elements,
a longitudinal angle transmitter on the boom, and
at least one cable extending longitudinally in the boom for detecting the actual length of the telescopic boom, the improvement comprising
a force sensor is provided on the cable to detect a longitudinal force in the cable.

2. The crane according to claim 1, wherein the cable is a steel rope and/or an electric cable.

3. The crane according to claim 1, wherein means are provided, by which the force sensor transmits a signal representing a force acting upon the cable to a controller of the crane.

4. The crane according to claim 3, wherein the means are designed for a wireless transmission, in particular via radio.

5. A method of operating a crane having
a base,
a pivotable boom comprising at least two telescoping boom elements,
a longitudinal angle transmitter having at least one cable for detecting the actual length of the telescopic boom
the method comprising the steps of:
by a force sensor on the cable for detecting a force acting longitudinally on the cable, and
on detection of a tension in the cable outside a predetermined noncritical range, taking action to suspend operation of the crane.

6. The method according to claim 5, wherein the force sensor transmits a signal representing a force acting upon the cable to a controller of the crane.

7. The method according to claim 6, wherein the transmission occurs continuously or discontinuously and, then, when a transmitted signal is absent, the controller detects a safety-critical state.

8. The method according to claim 6, wherein the controller assesses the transmitted signal and, when it is outside a non-critical range, the controller detects a safety-critical state.

9. The method according to claim 6, wherein the transmission of the signal occurs redundantly.

10. The method according to claim 9, wherein the redundant transmission of the signal occurs only via the cable (12) designed as a data cable, only wirelessly, or via the cable (12) designed as a data cable and wirelessly.

11. A method of operating a crane having:
a base;
an adjustable-length boom pivotal on the base and formed by at least one outer boom element and at least one inner base-mounted boom element telescoping with the outer element; and
a cable extending between an outer end of the outer boom element and the inner boom element so as to be pulled out on extension of the outer boom element from the inner boom element;
the method comprising the steps of:
detecting tension in the cable and generating an output corresponding thereto;
determining when the tension in the cable is outside a predetermined noncritical range; and
taking action to suspend operation of the crane on determination that the tension is outside the noncritical range.
